(19) United States
(12) Patent Application Publication
(10) Pub. No.: US 2008/0164206 A1
(43) Pub. Date: Jul. 10, 2008

(54) Method and apparatus for removing minerals from a water source

(75) Inventor: Leonard L. Dueker, Mesa, AZ (US)

Correspondence Address: LAVALLE D. PTAK;LAW OFFICE OF LAVELLE PTAK, 28435 N 42ND STREET, SUITE B, CAVE CREEK, AZ, 85331, US

(73) Assignee: Southwest Turf Solutions, Inc.

(21) Appl. No.: 11/652,204

(22) Filed: Jan. 10, 2007

(51) Int. Cl. B01D 65/02; B01D 24/00; B01D 29/56; C02F 1/44

(52) U.S. Cl. 210/636; 210/266; 210/255

(57) ABSTRACT

A system and method for removing minerals from a water source and concentrating these minerals for ease of reuse or disposal includes first passing the water from a suitable source through an input stage consisting of a micro filtration filter or an ultra filtration filter. The output of this input stage is coupled with cascaded membrane filters in various combinations. Periodic backwashing of the input filter stage produces backwash supplied to a slow sand filter, the output of which is supplied back to the input stage in combination with the water from the source of water.

### RELATED APPLICATION

This application is related to co-pending application Ser. No. 11/499,160 filed on Aug. 3, 2006 and assigned to the same assignee.

### BACKGROUND

Many municipal water sources include high concentrations of dissolved minerals, at least some of which must be removed prior to supplying the water to ultimate consumers. In addition, particularly in areas of limited water supply, sewage effluent is processed for use in watering golf courses, parks and the like. Such effluent also generally includes a high concentration of minerals, which need to be removed prior to delivery of the processed effluent. The removal and concentration of minerals by systems currently in use by most municipalities is economically feasible only if large quantities of liquid are processed. For systems processing three million gallons of water per day or less, there presently are no practical and economical processes available.

There are several methods of concentrating reject water from water processing systems for disposal of that reject water. Such methods include evaporation ponds, high efficiency reverse osmosis, thermal brine concentration, brine crystallization, and others. Whichever of these methods is used, however, removal and concentration of minerals typically is economical only if large quantities of water (in excess of three million gallons per day) are processed.

Evaporation ponds frequently are used to concentrate the brine or mineral concentrate of reject water from a water processing system. Depending upon the climate and temperature (that is, sunshine, rain or snow), the evaporation rate varies. Different rates of evaporation require varying areas for the evaporation pond because the losses due to evaporation also vary by the area of the water surface exposed to the atmosphere. Evaporation pond processes require large areas of land, even when they are used in regions of relatively abundant sunshine and low humidity. Particularly in regions of concentrated population, the cost of the land for the evaporation pond can be very expensive unless the reject brine from the water processing system can be concentrated to a very small relative quantity of liquid.

High efficiency reverse osmosis (RO) processes consist of lime softening, hardness polishing through weak acid, cation exchange, pH increase to 10.5, and reverse osmosis with sea water RO membranes. The addition of chemicals in such systems does not lend itself to small applications. These processes typically are used in conjunction with obtaining drinking water from sea water. Such systems are relatively expensive and generally are not practical for processing smaller quantities of water (three million gallons per day or less).

A different technique which has been used in the past for concentrating reject water for disposal is thermal brine concentration. Systems using thermal brine concentration recover some of the waste stream through evaporation and vapor compression in large facilities. Thermal brine concentration systems require the addition of energy in the form of heat and pumping costs. This process, because of the size of the equipment required, does not lend itself to small applications of three million gallons per day or less.

Another method for removing and concentrating reject water from a water processing system is thermal flash evaporation for producing brine crystallization. This method causes the formation of salt crystals in a brine solution; but it requires energy to maintain the process under pressure, circulation, and requires the addition of heat. Thermal flash evaporation requires relatively massive large-scale equipment, and again, does not lend itself to applications of under three million gallons per day.

Electrolysis reversal (EDR) technology has been used for many years. This technology, however, has had limited testing and application in treating wastewater tertiary effluent for re-use. Even with an EDR system, fouling can be a particular concern when treating tertiary effluent from a municipal wastewater treatment plant.

Water treatment using reverse osmosis (RO) technology leaves a reject stream with a concentration of suspended solids plus added anti-scalant, anti-flocculent chemicals, dissolved organics, minerals and other pollutants, which are removed from the product water produced by the RO technology. The disposition of this reject stream may be processed by some of the methods discussed above; but disposition is difficult in many situations. For some cases, the reject stream pollutants pose a liability for the users of the product water. In addition, the loss of 10% to 50% reject for any beneficial use also poses a problem in water short areas, where all water resources are needed.

High-shear membrane filtration systems employ three different technologies; vibration, spinning disc, and spinning cylinder. All use high shear to keep membranes clean, but they do it in different ways. These new systems enable membranes to be used in applications ranging from the treatment of wastewater to delicate biotech separations:

Spinning Disc

Dynamic membrane (DMF) filtration prevents fouling through the creation of intense shear forces that lift away foulants. DMF generates its shear forces in the gaps between rotating solid discs and stationary membrane surfaces that flank the discs on either side.

Spinning Cylinder

Vortex flow perfusion (VFP) is similar to DMF in function, but different in execution. Like DMF, the VFP system separates out valuable substances in small volumes of liquid, and improves the thoroughness of separation and the flux by dispersing the gel layer. However, instead of using parallel shear to prevent fouling, VFP generates toridial vortices all over the surface of the active membrane by a spinning, cylindrical rotor mounted in a tubular casing.

Vibration Antifouling Technology

Vibration antifouling technology moves the membrane itself instead of pumping water across the membrane to produce the shear.

In addition to the foregoing, vibrating membrane filters use various types of membranes (reverse osmosis, nanofiltration, and others). Normal membrane filtration, such as reverse osmosis or nanofiltration, use cross-flow filtration which relies on high velocity fluid flow pumped across the membrane surfaces as a means of reducing fouling of the membrane. In cross-flow designs, this high velocity fluid flow produces shear forces measuring ten to fifteen thousand inverse seconds. Vibrating the membranes produces shear forces measuring up to 150,000 inverse seconds (equivalent to over 200 GS of force) on the face of the membranes. These shearing forces are produced by vigorously vibrating the membranes in a direction tangent to the surface of the membranes. The feed slurry or feed water remains nearly stationary, moving in a leisurely, meandering flow between parallel membrane elements. In cross-flow designs, the flow is moving very rapidly across the surface of the membranes.

In a vibrating membrane application, the membranes to be vibrated are held in a membrane filter pack, which consists of membrane elements arranged as parallel discs separated by gaskets. The entire filter pack is oscillated back and forth. The vibration amplitude and corresponding shear rate also can be varied to directly affect the filtration rates. Typically, the pack of a vibrating membranes filter oscillates at a frequency of approximately 53 Hz, with an amplitude of three-fourths to one and one-fourth inches peak-to-peak displacement at the rim of the pack. The motion is analogous to the agitator in a clothes washing machine; but the motion occurs at a speed faster than that which can be perceived by the human eye. The operating pressure can vary up to 1,000 PSI. The greater the pressure, the greater the energy required. Therefore, an operating pressure is used, which optimizes a balance between flow rates and energy.

Although high-shear membrane separators perform well as a whole, each particular technology has conditions and applications in which it works best. The main difference between spinning disc and cylinder, and vibratory modules is the amount of energy required to run each one. For example, in a spinning disc, a motor can drive only a few of the discs, each of which keeps only two membranes clear. At the same time, a slightly stronger motor can be used in a vibratory module to keep hundreds of membrane surfaces clean. As a result, vibratory machines are more energy efficient.

The treatment of water with a slow sand and natural filtration system is shown in the U.S. Pat. to Cluff No. 5,112,483 for scaling control to provide good quality water for many purposes at a reasonable cost. The system disclosed in the Cluff patent uses a slow sand filter to receive the water being treated. The output of the slow sand filter then is supplied to a cascade of nano-filtration filters. These may include a catalytic conditioner or magnetic water conditioner in the system. Although the system of the Cluff patent exhibits improved efficiency, a relatively high percentage of reject and the attendant disposal problems for the reject still are present in the system. In addition, since a slow sand filter must process all of the water supplied to the system, large areas of land are required relative to the amount of water being processed. The Cluff system, however, does provide combined benefits of nano-filtration units and a slow sand filter.

As is well known, slow sand filters not only serve to physically filter the sediment and other impurities from water supplied to the filter, but also provide a conducive environment for microorganisms which further purify the water, removing some organic matter. The microorganisms modify the electrical charge so that clay is easily removed by the slow sand filter. The biological treatment produced by slow sand filters is not available in rapid sand gravity or pressurized filters. Unlike with slow sand filters, clay removal is not accomplished without the use of flocculents in rapid sand gravity or pressurized filters. Unused flocculents foul RO membranes, thereby precluding the use of rapid sand gravity or pressurized filters as a pre-filter in an RO or other membrane type of filter.

Whenever a membrane filter such as reverse osmosis (RO), nano-filtration filters, and sea water membranes are used, common filters used to pre-filter the water entering the membrane filters are micro filtration and ultra filtration filters. Slow sand filtration also has been used, either as the sole filtration system v in a water processing treatment plant, or as a pre-filter for membrane or cascading membrane filters. As mentioned above, however, for processing any given quantity of water, slow sand filters require relatively large areas of land.

It is desirable to provide an improved system and method for removing minerals from a source of water which overcomes the disadvantages of the prior art.

### BRIEF DESCRIPTION OF THE DRAWINGS

FIG. 1 is a block diagram of a prior art slow sand filter;

FIG. 2 is a block diagram of a micro/ultra filtration system of the prior art;

FIG. 3 is a block diagram of an improved filtering system in accordance with an embodiment of the invention; and

FIGS. 4 through 14 are block diagrams of various embodiments of the invention.

### DETAILED DESCRIPTION

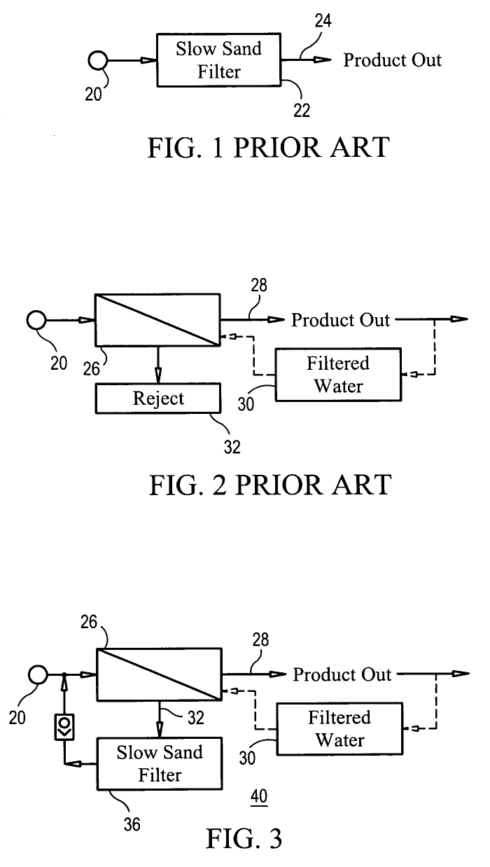

As mentioned above in the background portion of this specification, slow sand filters have been used extensively in the past to treat waters of all types. FIG. 1 shows a block diagram of a typical slow sand system where the feed water 20 is supplied to the slow sand filter 22 with an output (filtered water) attained at 24. The feed water 20 may be obtained from streams, rivers, lakes, canals, wells, oceans, marshes, sewers, water treatment plants, and wastewater treatment plants.

The advantage of slow sand filters is that they do not need to be backwashed. They are cleaned periodically by removing a small amount (typically ⅜″) of sand and material from the top of the sand in the filter. After an extended period of time, new sand may be placed in the filter to replace the sand previously removed. The disadvantage of using slow sand filtration for processing large quantities of water is that such filters require large areas of land on which to place the filters for any given quantity of water. Where land is at a premium or space simply is not available, slow sand filters become impractical; although they have many advantages, as described above.

FIG. 2 is a block diagram of a prior art micro filtration or ultra filtration system which is commonly used to filter water prior to treating the water with a membrane type filter, such as an RO filter. In a micro filtration or ultra filtration system, the feed water 20 is fed to the filter 26 to produce product water 28 at the output. A disadvantage of a micro filter or ultra filter, however, is that such a unit as the unit 26 must be backwashed using relatively large quantities of the filter output (product output) water to accomplish the backwashing. Consequently, as shown in FIG. 2 in the dotted line configuration, some of the product output water, in the form of filtered water 30, periodically is forced through the reverse direction of the filter 26 to remove contaminants which are carried away in a backwash or reject 32. This reject 32 must be disposed of. Typically, the quantity of filtered water 30 used for a backwash is in the 6% range of the total product water 28 to produce the reject 32. Thus, for three million gallons of feed water 20 per day, 180,000 gallons per day of backwash or reject 32 must be disposed.

In accordance with an embodiment of the invention, a modification of the prior art filtration systems shown in FIGS. 1 and 2 is employed to significantly reduce the amount of reject or backwash water which must be disposed of in a water processing filtration system. As shown in the filter 40 of FIG. 3, the feed water 20 is supplied to a micro filter or ultra filter 26 to produce the desired product out at 28, essentially the same as illustrated in FIG. 2. Filtered water 30 then is used periodically to backwash the membranes of the filter 26, as described above in conjunction with FIG. 2. In FIG. 3, however, this reject is supplied to a slow sand filter 36, the output of which is supplied through a check valve or other technique to combine with the feed water 20 at the input of the micro filter or ultra filter 26. No reject requires disposal with this arrangment. Because the amount of water being processed by the slow sand filter 36 is not the entire quantity of feed water 20, the slow sand filter 36 may be much smaller in area than would be required.

As is mentioned in the above example, for processing three million gallons of feed water 20 in the filter of FIG. 3, the slow sand filter 36 only must be capable of processing 180,000 gallons per day of the backwash water. Similar reductions in area of the slow sand filter 36 over the one shown in the system of FIG. 1 are attained for whatever quantity of feed water 20 is to be processed by the system using the configuration of FIG. 3 as either a pre-filter, or as the complete filter for the system. All of the advantages of a slow sand filter 36 which have been discussed above in conjunction with the filter of FIG. 1 are present in the system of FIG. 3; and the filter of FIG. 3 does not produce reject water requiring disposal, but rather utilizes to the maximum extent possible, all of the feed water supplied through the system for subsequent utilization.

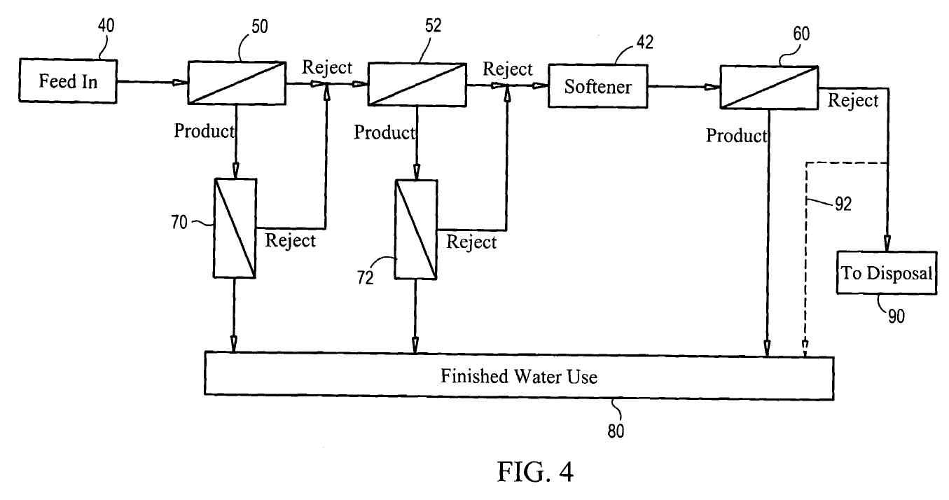

FIGS. 4 through 11 all are directed to various embodiments of the invention used in water treatment systems for removing minerals from a feed water source. In each of the embodiments shown in FIGS. 4 through 11, the feed water is supplied through a pre-filter system 40 of the type shown in FIG. 3 and described above. By the use of the filter 40, a significant amount of contaminants and suspended particles are removed through the combination of the micro/ultra filter unit 26 and the slow sand filter 36. Consequently, in the discussion of the systems disclosed in FIGS. 4 through 11, it should be noted that the feed water shown as feed in 40 already has been pre-processed prior to its application to the remainder of the units of the various embodiments in these different figures.

In FIGS. 4 through 14, different types of membrane filters are employed in various combinations. To aid in an understanding of all of these figures, nano filter units are provided with reference numbers between 50 and 58. Sea water membrane units are provided with reference numbers 60 through 68; RO (reverse osmosis) membrane filtration units are provided with reference numbers from 70 through 78; and vibrating membrane units are provided with reference numbers 82 to 88. Consequently, any time a filter unit is shown with a reference number in the 50's, it is a nano filter. Reference numbers in the 60's represent sea water filters; and reference numbers in the 70's represent RO filters; and reference numbers 82 to 88 represent vibrating filters.

In FIG. 4, the feed water from the unit 40 is supplied to a first nano filter 50. Using a nano filter 50 as the input membrane filter permits the treatment of waters containing a very high level of hardness and other constituents which would foul a reverse osmosis (RO) or sea water membrane filter. Although the unit 40 of FIG. 3 ideally is used as the feed to the nano filter 50, a slow sand filter as shown in FIG. 1 or a pre-filter of the type shown in FIG. 2 also could be used, with, however, the attendant disadvantages mentioned above in conjunction with both of these figures. For maximum efficiency in land area required and for optimum utilization of the original feed water 20, the system of FIG. 3 is preferred; and that is the reason it is shown in all of FIGS. 4 through 11.

A nano filtration filter, such as the filter 50, also known as a “softening filter” removes hardness and other fouling constituents supplied as reject to the next stage in the cascade. The product or permeate further must be passed through a reverse osmosis (RO) filter, such as the filter 70, or a sea water unit to remove the TDS (total dissolved solids), sodium and chloride. The product (permeate) from the reverse osmosis system 70 then is supplied to a finished water use 80; and the reject from the reverse osmosis system filter 70 is supplied to join the reject from the nano filter 50 as the feed input to a second cascaded nano filter 52. Once again, the product from the nano filter 52 is supplied through a reverse osmosis (RO) filter 72 to remove additional TDS, sodium and chlorides from the product supplied to the finish water use 80. The reject from the RO filter 72 is combined with the reject from the nano filter 52, and in FIG. 4, is supplied to a softener 42.

The softener 42 is used to remove hardness and other fouling constituents. Typically, the softener 42 uses an ion exchange process or a lime treatment or lime plus soda ash treatment to precipitate calcium (CA) and magnesium (Mg) out of the reject stream from the water flow prior to supplying the reject stream to the input of a sea water membrane filter 60. The product (permeate) from the filter 60 is supplied to the finished water use 80, along with the outputs of the RO filters 70 and 72; and the reject from the sea water filter 60 is supplied to suitable disposal 90. In some cases, a softener 42 may be used following the first filter, be it RO, nano, or vibrating. In these instances, the softener 42 shown in FIGS. 4, 7 and 8 would not be used.

In some cases, the finished water use 80 may require the addition back of some of the removed minerals, depending upon the use which is intended for the finished water at 80. For example, if the finished water use 80 is for a golf course, a portion (to be selected by the ultimate user of the water at 80) of the reject from the sea water unit 60 may be supplied back to the finished water use 80 to cause the hardness or other characteristics of the finished water use 80 to be tailored to the desires of the ultimate user.

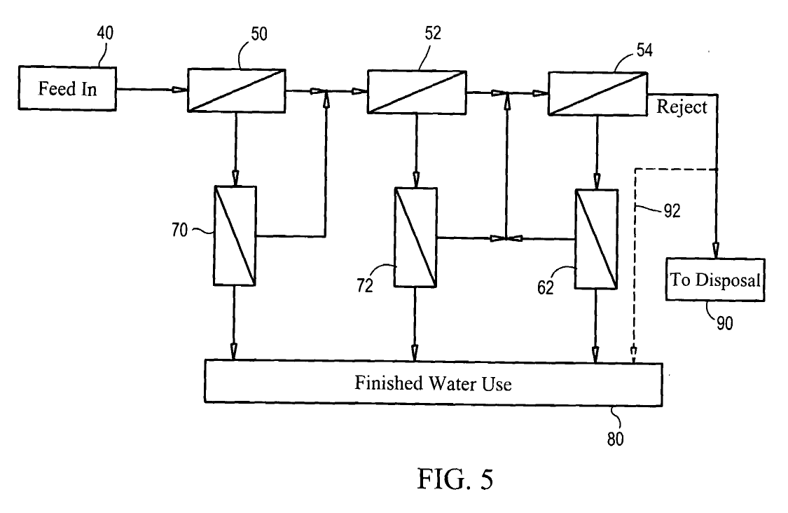

FIG. 5 is a system which is similar to the one shown in FIG. 4, but which employs no softener.42. In the system of FIG. 5, three nano filtration units 50,52 and 54 are connected in cascade with one another, with the feed 40 being supplied to the first of the nano filtration units 50. The reject from the system shown in FIG. 5 is obtained from the last of these three nano filtration units and is supplied to a disposal 90, as discussed above in conjunction with FIG. 4. In the system of FIG. 5, however, the nano filtration units 50 and 52 each supply the product output to the corresponding RO filter 70 and 72 in the same manner as described above in FIG. 4. The final nano filtration unit 54, however, supplies its product to a sea water unit 62, the reject of which is combined with the reject from the RO filter 72 and supplied back to the input of the nano filtration unit 54. The output of the sea water unit (product output) 62 is supplied along with the product outputs of the RO filters 70 and 72 to the finished water use 80.

As described above in conjunction with FIG. 4, the system shown in FIG. 5 also has an option illustrated by the dotted lines 92, which permits, as desired, some or all of the hardness (calcium (Ca) and magnesium (Mg)) to be placed back into the finished product. This is desirable if the product water requires some hardness, such as drinking water and turf irrigation.

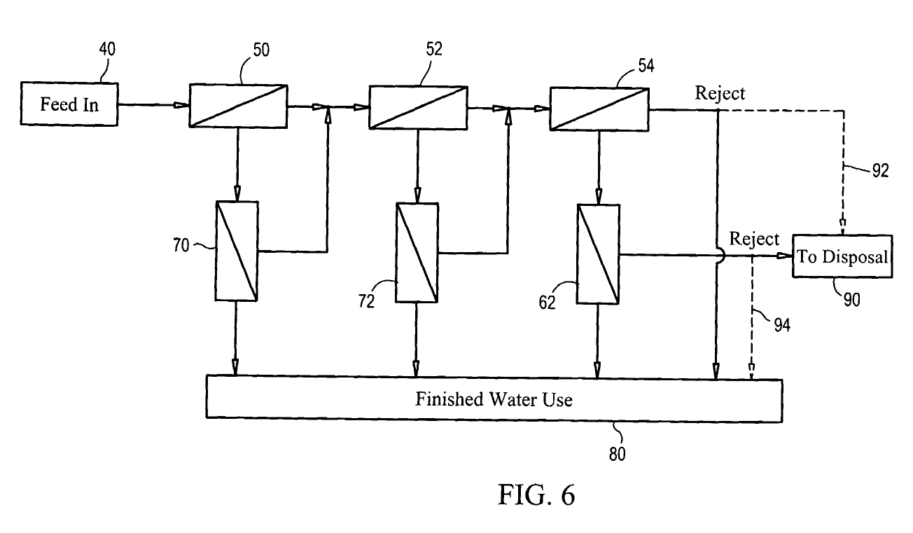

The system shown in FIG. 6 is nearly the same as the one shown in FIG. 5, and uses three cascaded nano filtration units 50,52 and 54 for processing the feed from the unit 40. The two RO filters 70 and 72 and the sea water filter 62 are connected to the respective nano filtration units 50,52 and 54 in the same manner shown in FIG. 5. The reject output of the sea water unit 62, however, is shown as all being supplied to the disposal 60; whereas the reject water from the nano filtration unit 54 is being shown as supplied to the finished water use 80. Alternatively, some or all of the reject from the nano filtration 54 may be sent to the disposal 90 via the dotted line connection shown at 92; and some or all of the reject from the sea water filter may be sent to the finished water use 80 via the dotted line connection 94, as desired. This permits the tailoring of the makeup of the finished water use 80 to be adjusted in accordance with the desires of the ultimate consumer of the water provided at 80.

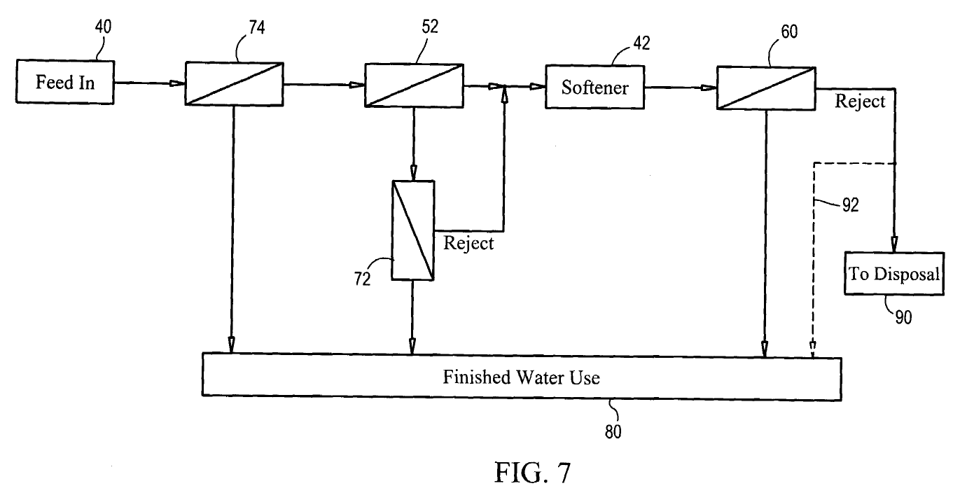

FIGS. 7 through 11 all are variations of systems which employ a reverse osmosis (RO) filter 74 for the first unit in the process. The feed from the input 40 is supplied to the input of the RO filter 74. These systems permit the treatment of waters which do not contain very high levels of hardness and other constituents which otherwise would foul reverse osmosis and sea water membrane filters. In all five of these figures, the feed water is supplied typically by the system 40 shown in FIG. 3, but could be supplied by the prior art systems of FIGS. 1 and 2 if the drawbacks of these systems are not a factor. The feed water then passes through the RO filter 74, which supplies product to a finished water use 80. The reject from the RO filter is supplied to a nano filter 52, the product of which is passed through an RO filter 72 for the reasons given above in the discussion of FIGS. 4 and 5. The reject from the RO filter 72 is combined with the reject from the nano filter 52 and supplied through a softener 42, which operates in the same manner as the softener 42 described in conjunction with FIG. 4. Finally, the output of the softener 42 is supplied to a sea water filter 60 as in the system of FIG. 4. The output of the sea water filter is sent to finished water use at 80. The reject from filter 60 goes to disposal 90, with an alternative of some or all of the reject of the sea water filter 60 being supplied. (via 92) to the finished water use 80 to alter the constituency or makeup of the finished water use 80 in accordance with the desires of the ultimate consumer.

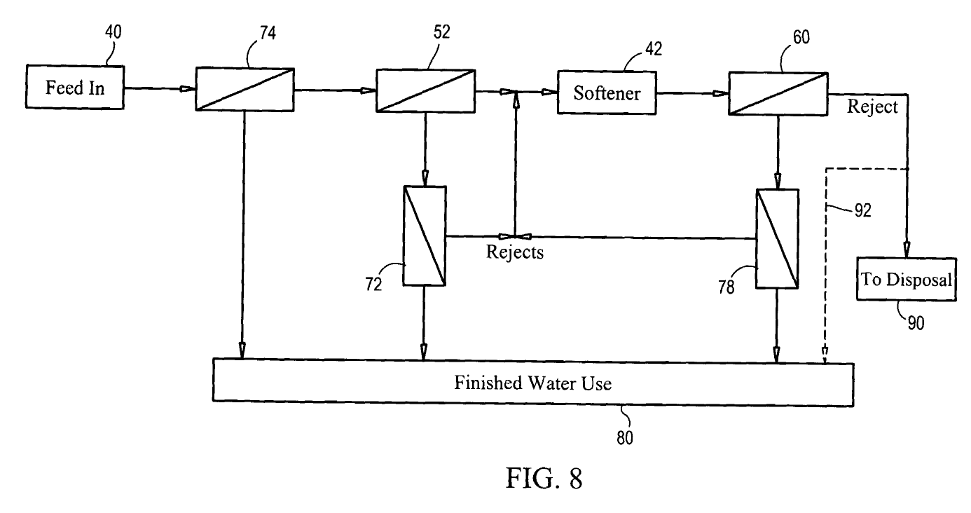

FIG. 8 is a variation of the system shown in FIG. 7, but one in which the product of the sea water filter 60 is supplied to the input of a second RO filter 78, with the reject from the RO filters 72 and 78 being supplied as the input to a softener 42 connected between the reject output of the nano filter 52 and the output of the sea water filter 60. In all other respects, the system of FIG. 8 operates in the same manner as the system of FIG. 7.

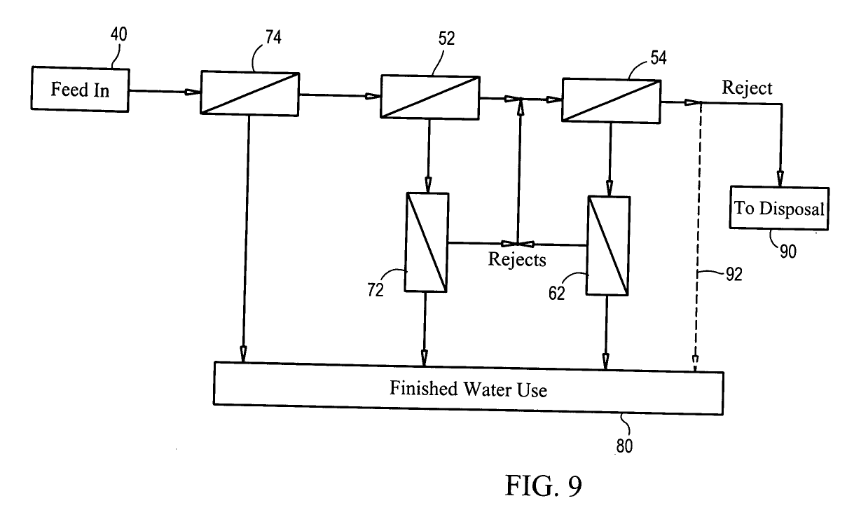

The system of FIG. 9 is a variation of the system shown in FIG. 6, but with an RO unit 74 at the input for the reasons given above in the general discussion of FIGS. 7 through 11. The reject output of the RO filter 74 is the input to a nano filtration unit 52, with the product of the filter 52 being supplied to an RO filter 72 in the same manner described above in conjunction with FIGS. 7 and 8. No softener is employed in the system of FIG. 9, however; and the output of the nano filter 52 is supplied to the input of a second nano filter 54, the output of which is supplied through a sea water filter 62, with the reject of the sea water filter 62 being combined with the reject from the RO filter 72 and supplied back to the input of the nano filter 54. The reject from the nano filter 54 is sent to disposal 90; or all or a portion of it may be diverted as shown at 92, and supplied back to the finished water use 80 to alter the makeup of the content of the water use 80.

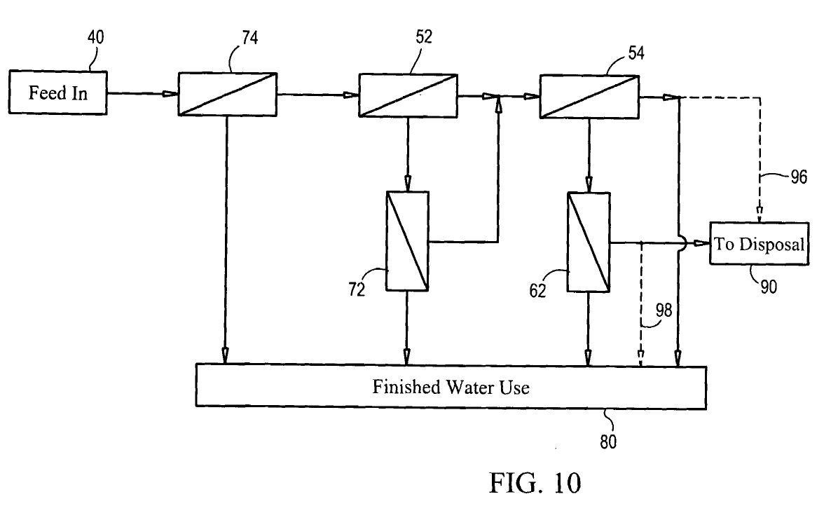

FIG. 10 is similar to FIG. 9; but the sea water filter 62 supplies its reject to the disposal 90 in a manner similar to that shown in FIG. 6. The reject from the second cascaded nano filter 54 is supplied to the finished water use 80, along with the product from the sea water filter 62, the RO filter 72 and the first RO filter 74. Again, depending upon the nature of the disposition of the finished water use 80, some or all of the reject from the nano filter 54 may be sent to disposal via the dotted line indication 96 and some or all of the reject from the sea water filter 62 may be sent, via 98 as shown in dotted lines, to the finished water use 80 to adjust the composition of the finished water use 80 in accordance with the desired ultimate use of that water.

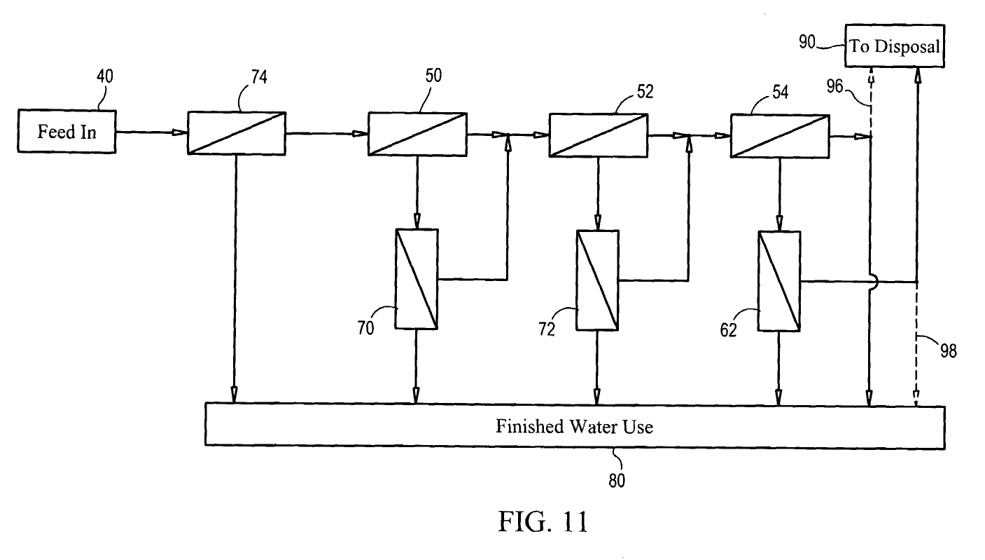

FIG. 11 is similar in many respects to the systems of FIGS. 6 and 10, and employs an RO filter 74 as the input stage for receiving the feed from the unit 40 as described above. In FIG. 11, however, the cascade of the reject from the RO filter 74 is through three additional nano filter units 50,52 and 54, each of which in turn supplies reject as input to the next one in the succession. As described above in conjunction with FIG. 6, the nano filtration units 50 and 52 supply product to the inputs of two RO filters 72; and the product output of the nano filter 54 is supplied to the input of a sea water filter 62. The product outputs of the RO filters 70 and 72 and the product output of the sea water filter 62 are supplied along with the product output of the RO filter 74 to finished water use 80. Typically, the reject output of the nano filter 54 also is supplied to the water use 80 unless the mineral content of this reject is not desired. Then, as shown in FIG. 11, some or all of this reject is diverted as shown in the dotted line connection 96 to disposal 90. Similarly, the reject output of the sea water unit generally is supplied to the disposal 90; but some or all of this output may be divided as shown at 98 to the finished water use 80, in the same manner described above in conjunction with FIG. 6.

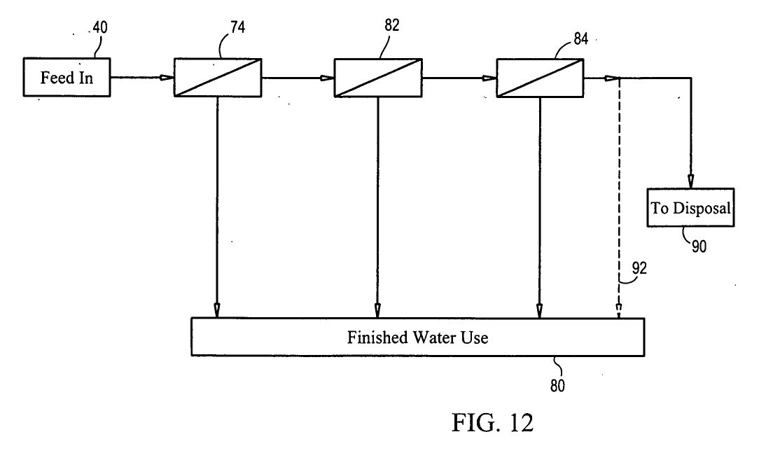

FIGS. 12, 13 and 14 illustrate embodiments of the invention which employ vibration filters as part of the filter cascade. In the system shown in FIG. 12, the input from the feed unit 40 is supplied to an RO unit 74 for the reasons given above in the general discussion of FIGS. 7 through 11. The reject of the RO filter 74 is the input to a first vibrating membrane unit 82 (which may be an RO filter, a nanofilter, or other membrane filter), with the reject from the filter 82 being supplied as the input to a second cascaded vibrating filter 84. The product from each of the filters 74,82 and 84 is supplied directly to the finished water use 80, with the reject from the vibrating filter 84 being supplied directly to disposal 90. As mentioned previously, depending upon the nature of the disposition of the finished water use 80, some or all of the reject water from the final vibrating filter 84 in the cascade may be sent, via 92 shown in dotted lines, to the finished water use 80 to adjust the composition of the finished water use 80 in accordance with the desired ultimate use of that water.

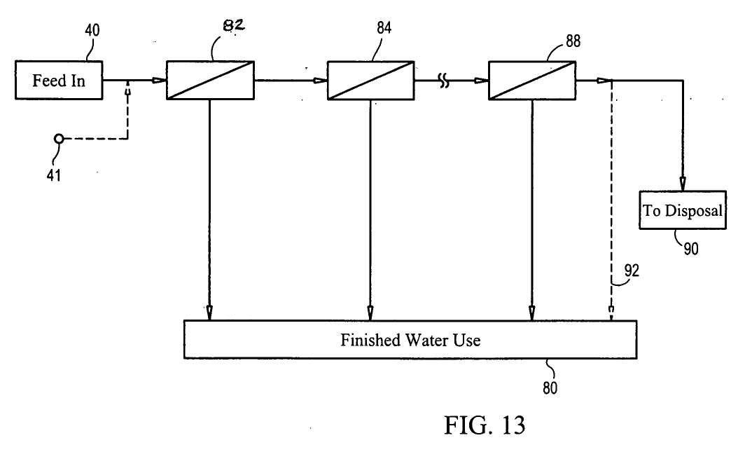

In FIG. 13, all of the membrane units in the cascading series are vibrating membranes. These are shown in FIG. 13 as vibrating membranes 82,84 and 88, with the reject of 82 being supplied to the input of membrane 84, and with any desired number of additional membranes as may be necessary being similarly connected in cascade with the reject of one supplying the input of the next in the cascade. In FIG. 13, the final vibrating membrane unit is shown as the unit 88. There may be a total of three vibrating membrane units, as illustrated, or any desired number as may be necessary in the cascade, with the connections between each of them being made in the same manner as illustrated in FIG. 13. The vibrating units may be RO units or nanofiltration units, depending upon the nature of the feed water and the nature of the reject from one unit to the next in the cascade.

As illustrated in FIG. 13, the feed may be either from the filter unit 40 as described previously, or it may be directly from a water source 41 without passing through such a filter, if the characteristics of the water source are such that it can be used in this manner. A vibrating unit, such as the unit 82, may be used in the first filtration unit in the cascade whenever the feed water, either supplied from the alternative source. 41 or from the filtration source 40, has a considerable amount of fouling material in it. If such a situation exists, the vibrating unit 82 would use ultra-filtration or micro-filtration membranes; and the following cascading membranes then could be reverse osmosis and/or nanofilters. On the other hand, the unit 82 could be an RO unit or a nanofiltration unit, depending upon the nature of the feed water; and the remaining vibrating units 84 to 88 could produce a very high TDS and other mineral concentrate. As discussed above in conjunction with FIG. 12, some or all of the reject from the final unit 88 may be supplied to the finished water use 80 to produce a blended output, as desired for the ultimate use to be made of the finished water.

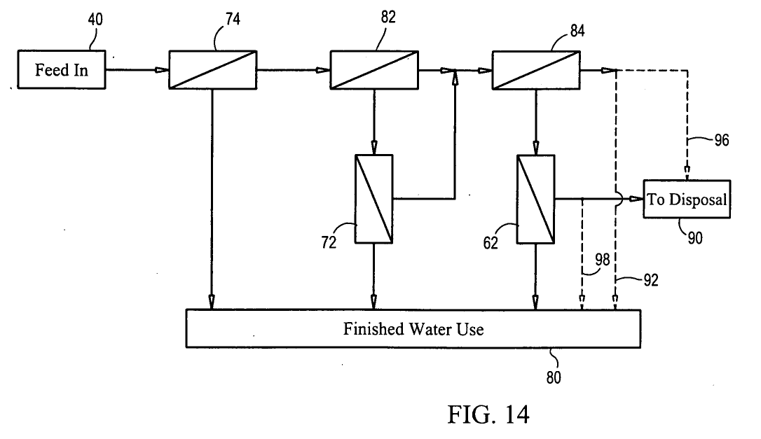

FIG. 14 is a system which is similar in many respect to the one shown in FIG. 10, with the exception that the nanofiltration units 52 and 54 of FIG. 10 have been replaced with vibrating membrane units 82 and 84. In all other respects, the operation of the system shown in FIG. 14 is similar to the operation of the system shown in FIG. 10. This includes the optional mixing of the reject from the final vibrating membrane filter 84 in the cascade and the reject from the sea water filter 62, via the dotted line connections 92 and 98, respectively, with the finished product in the finish water use 80, as desired for the ultimate use to be made of the water output from the filtration system.

FIGS. 4 through 11 illustrate various embodiments of water processing systems for removing minerals from a water source. By using the cascaded filters and by using combinations of RO filters, nano filters, and sea water filters as membrane filters after an initial pre-filter stage, the tailoring of the content of the product water shown as the finished water use 80 in the various drawings may be effected in accordance with the desires of the ultimate user. Clearly, other combinations of membrane filtration units in accordance with the principles shown in the various embodiments of FIGS. 4 through 11 also may be made within the scope of the invention.

The foregoing descriptions of different embodiments of the invention are to be considered as illustrative and not as limiting. Modifications will occur to those skilled in the art for performing substantially the same function, in substantially the same way, to achieve substantially the same results without departing from the true scope of the invention as defined in the appended claims.

What is claimed is:

1. A method for removing minerals from a water source including: passing water from a source of water through a first filter unit in the form of a micro filtration or ultra filtration filter; supplying the output of the first filter unit to a point of use; periodically backwashing the first filter unit; supplying the backwash from the first filter unit to a slow sand filter; and supplying the output of the slow sand filter to the input of the first filter unit to combine with water from the source of water.

2. A method according to claim 1 further including supplying the output of the first filter unit to a cascaded connection of membrane filters; supplying the reject output of each of the membrane filters to the input of the next succeeding membrane filter in the cascade; and supplying the product output of the membrane filters to the point of use.

3. A method according to claim 2 further including supplying the product of at least one of the membrane filters in the cascade to the input of a further membrane filter and supplying the reject output of the further membrane filter to the input of the next membrane filter in the cascaded membrane filters.

4. A method according to claim 3 further including supplying the reject output of the last membrane filter in the cascaded membrane filters at least in part to combine with the product output of the membrane filters to the point of use.

5. A method according to claim 2 further including supplying the reject output of the last membrane filter in the cascaded membrane filters at least in part to combine with the product output of the membrane filters to the point of use.

6. A system for removing minerals from a water source including: a source of water; a first filter unit in the form of a micro filtration filter or an ultra filtration filter having an input connected to the source of water and also having a product output and a backwash output; a slow sand filter having an input connected with the backwash output of the first filter unit and having an output connected to the input of the first filter unit in combination with the source of water.

7. A system according to claim 6 further including a cascade of membrane filters, each having an input, a product output and a reject output, with the input of the first filter in the cascade connected to the output of the first filter unit, and the reject output of each filter in the cascade (except the last) connected to the input of the following filter.

8. A system according to claim 7 wherein the membrane filters are selected from the class of reverse osmosis filters, nano filtration filters, sea water filters, and vibration membrane filters.

9. A system according to claim 8 wherein the cascade of membrane filters includes at least three membrane filters, with the output of the first filter unit supplied to the first membrane filter and the reject output of the first membrane filter supplied to the input of the second membrane filter, and the reject output of the second membrane filter supplied to the input of the third membrane filter in the cascade.

10. A system according to claim 9 further including at least one additional membrane filter connected to the product output of at least one of the membrane filters in the cascade of filters, with the product output of the further membrane filter supplied to a point of use and the reject output of the further membrane filter supplied to the input of the next membrane filter in the cascade of membrane filters.

11. A system according to claim 9 wherein the last membrane filter in the cascade of membrane filters provides the reject output of the system and further wherein at least a part of the reject output is supplied to the point of use.

12. A system according to claim 11 wherein the additional filter is a reverse osmosis filter.

13. A system according to claim 12 wherein the first membrane filter in the cascade of three membrane filters is a reverse osmosis filter and the second and third filters in the cascade of filters are nano filtration filters.

14. A system according to claim 7 wherein the cascade of membrane filters includes at least three membrane filters, with the output of the first filter unit supplied to the first membrane filter and the reject output of the first membrane filter supplied to the input of the second membrane filter, and the reject output of the second membrane filter supplied to the input of the third membrane filter in the cascade.

15. A system according to claim 14 further including at least one additional membrane filter connected to the product output of at least one of the membrane filters in the cascade of filters, with the product output of the further membrane filter supplied to a point of use and the reject output of the further membrane filter supplied to the input of the next membrane filter in the cascade of membrane filters.

16. A system according to claim 7 wherein the last membrane filter in the cascade of membrane filters provides the reject output of the system and further wherein at least a part of the reject output is supplied to the point of use.

17. A system according to claim 16 wherein the additional filter is a reverse osmosis filter.

18. A system according to claim 8 wherein the last membrane filter in the cascade of membrane filters provides the reject output of the system and further wherein at least a part of the reject output is supplied to the point of use.

19. A system for removing minerals from a water source including: a source of water; a cascade of at least three membrane filters, each having an input, a product output and a reject output, with the source of water connected to the input of the first membrane filter in the cascade and with the reject output of each of the membrane filters in the cascade supplied to the next input of the next succeeding membrane filter in the cascade, with the reject output of the last membrane filter in the cascade supplied to disposal; a point of use and the product output of each of the membrane filters in the cascade supplied to the point of use.

20. A system according to claim 19 wherein at least two of the membrane filters in the cascade of filters are vibrating membrane filters.
